(19) United States
(12) Patent Application Publication
(10) Pub. No.: US 2026/0199997 A1
(43) Pub. Date: Jul. 16, 2026

(54) ANTI-DEFORMATION AND FAST HEAT CONDUCTION AND DISSIPATION WELDING METHOD FOR COMPUTER CABINETS

(71) Applicant: AEON LIGHTING TECHNOLOGY INC., NEW TAIPEI CITY (TW)

(72) Inventor: JAMES LIANG, NEW TAIPEI CITY (TW)

(21) Appl. No.: 19/019,479

(22) Filed: Jan. 14, 2025

(51) Int. Cl. B23K 9/00; B23K 26/122; B23K 101/36

(52) U.S. Cl. CPC B23K 9/0061; B23K 26/122; B23K 2101/36

(57) ABSTRACT

An anti-deformation fast heat conduction and dissipation welding method for computer cabinets includes: setting a liquid storage space, with a size corresponding to a size of a combined structure of multiple components to be welded, for containing a working fluid; providing an underwater welding equipment, with a welding head that can extend to the liquid storage space and perform a welding process at a set distance below liquid surface; providing a welding fixture for temporarily fixing the components to be welded and placing them into the liquid storage space; using the welding head of the underwater welding equipment for entering into the working fluid to combine the components to be welded as a whole; and placing the welded components in the working fluid and removing them after cooling, so as to quickly dissipate the heat generated in the welding process to avoid deformation and improve product quality significantly.

### BACKGROUND OF THE DISCLOSURE

### Technical Field

The present disclosure relates to the field of computer cabinet equipment manufacturing technologies, and particularly relates to an anti-deformation fast heat conduction and dissipation welding method for computer cabinets, which uses underwater welding technology on land to quickly dissipate heat and prevent deformation.

### Description of the Related Art

With the increasing popularity of AI technology, the demand for various data centers and information centers has become more and more enormous. However, server cabinets and racks are indispensable to the data centers or information centers. The server cabinets are also known as computer cabinets, and most of the cabinets are connected to one another by welding. Welding is the process of melting metal at high temperatures to create a molten pool on the surface of the metal. When cooled, the tightness of the weld is extremely high, and the welded surfaces can be made smooth and unmarked by grinding, baking and varnishing the weld pass (weld joint). Since the metals are fused together, it features high strength, load-bearing capacity and shock resistance. After all, Taiwan has a lot of fault zones, and valuable servers and other equipment cannot withstand strong shaking. Therefore, the data centers or information centers have to take into account the computility, that is, the computational ability to generate information, process data and achieve the desired results and outputs. The demand for computility will be higher and higher, the quantity of servers will also have to be increased, data centers must have the flexibility to expand, and whether a cabinet can accommodate a sufficient number of servers while maintaining safety is a major test. In addition, standard cabinets can be combined by welding and sprayed with a galvanized paint to prevent rusting.

Rusting of the cabinet may result in brittleness, skewness, and loss of load-bearing capacity, thus affecting the safety of server storage. If it is necessary to take care of both aesthetics and strength, a lot of factors must be considered, because welding is a very profound knowledge, not only relating with the type of metal used, but also relating with thickness, contact area, coefficient of expansion, use of gas, source of high-temperature energy, preheating temperature, weld pass temperature, operator's craftsmanship and other factors. If part of the metal surface is not melted into the molten pool due to insufficient temperature and then cooled off, it will result in unequal weld leg lengths on both sides, leading to skewing and uneven force, which will weaken the strength of the weld and cause safety issues when the computer cabinet is loaded with loads or subjected to impact forces.

Underwater welding seems to be a way to solve the above problems. Since the number of various offshore oil platforms, submarine oil and gas pipeline construction, emergency repair of offshore vessels, underwater mineral development and nuclear power facilities and other projects is increasing for oceanic development, the construction and maintenance of these underwater projects requires underwater welding technologies, so these technologies are quite mature. These technologies are used for underwater operations and can quickly cool down high temperature after welding to minimize the problem of deformation. However, computer cabinets are not welded underwater, and it is not even possible to transport the material underwater at a low cost, so that there is a need to improve the technologies.

In view of the aforementioned problems of the related art, the discloser of the present disclosure conducted extensive research to make improvements, and finally developed an anti-deformation fast heat conduction and dissipation welding method for computer cabinets that creates a liquid storage space for underwater welding, temporarily fixes various components to be welded and places them below liquid surface, and only allows part of the underwater welding equipment to enter the working fluid in order to perform the welding process. There is no need for operators to enter the working fluid for the operation, not only reducing the difficulty of the process, but also avoiding the potential danger of the operators’ operation in the working fluid. This underwater welding technology is used to quickly dissipate the heat generated during the welding process, in order to prevent deformation and replace the related-art welding technologies.

### SUMMARY OF THE DISCLOSURE

The primary objective of the present disclosure is to provide an anti-deformation fast heat conduction and dissipation welding method for computer cabinets, which uses the underwater welding technology on land to achieve the effects of quickly dissipating heat and preventing deformation.

To achieve the aforementioned objective, the present disclosure discloses an anti-deformation fast heat conduction and dissipation welding method for computer cabinets, wherein each computer cabinet is assembled by welding a plurality of components to be welded including a base, a top cover, a frame and various metal components, for quickly dissipating the heat generated in a welding process to avoid deformation, the method comprising the steps of: setting a liquid storage space, with a size corresponding to the size of the base, the top cover, the frame and the components to be welded after they are combined, wherein the liquid storage space contains a working fluid for heat dissipation; providing an underwater welding equipment, with a welding head that can extend to the liquid storage space and perform a welding process for a set distance under the liquid surface of the working fluid; providing a welding fixture to temporarily fix the components to be welded onto the welding head and then place the components to be welded into the liquid storage space, such that the components to be welded are completely enclosed in the working fluid; using the welding head of the underwater welding equipment to enter into the working fluid to perform the welding process, and to combine the components to be welded as a whole; and placing the welding fixture together with the already welded components in the working fluid until they cool down, and then removing them from the liquid storage space to complete the welding process.

In an embodiment of the present disclosure, the working fluid is one selected from an anti-rust fluid and a cleaning fluid, and the set distance is greater than or equal to 15 centimeters.

In another embodiment, in the step of “using the welding head of the underwater welding equipment to enter into the working fluid to perform the welding process, and to combine the components to be welded as a whole”, the welding fixture is provided with a multi-directional rotating device for rotating the welding fixture at multiple angles to maintain the set distance of the welding process. In the same procedure, the present disclosure further provides a constant temperature circulation means, for connecting the liquid storage space to keep the circulation of the working fluid and maintain at a constant temperature, so there will be no drastic temperature fluctuation. In addition, according to the welding requirements, such as the requirements for linear welding, the present disclosure provides a slide rail, located under the welding fixture for driving the welding fixture to move linearly, so that the welding head can be fixed at the same position to perform the welding process and form a stable movement pattern for linear welding. For multi-point welding, the present disclosure can also provide a robotic arm for fixing the welding head, so that the welding head can be driven by the robotic arm to perform a programmed welding process and the multi-point welding process.

### BRIEF DESCRIPTION OF THE DRAWINGS

FIG. 1 is a schematic view showing the configuration of a preferred embodiment of the present disclosure;

FIG. 2 is a flow chart showing the procedure of a preferred embodiment of the present disclosure;

FIG. 3 is a schematic view showing a status corresponding to the step S1 of a preferred embodiment of the present disclosure;

FIG. 4 is a schematic view showing a status corresponding to the step S2 of a preferred embodiment of the present disclosure;

FIG. 5 is a schematic view showing a status corresponding to the step S3 of a preferred embodiment of the present disclosure;

FIG. 6 is a schematic view showing a status corresponding to the step S4 of a preferred embodiment of the present disclosure; and

FIG. 7 is a schematic view showing a status corresponding to the step S5 of a preferred embodiment of the present disclosure.

### DESCRIPTION OF THE PREFERRED EMBODIMENTS

The following description together with the attached drawings are provided to enable our examiner to clearly understand the technical contents of the present disclosure.

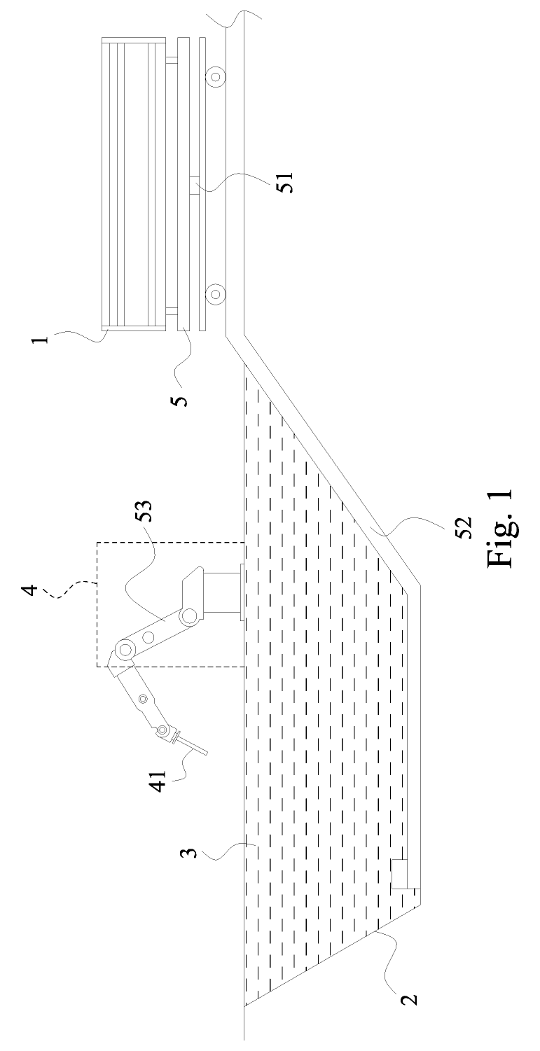

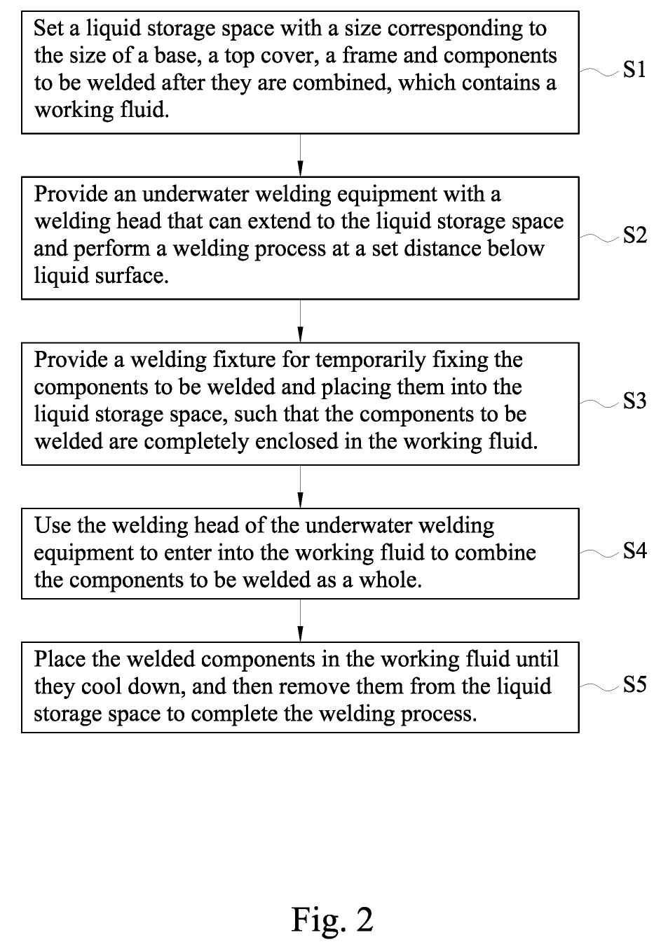

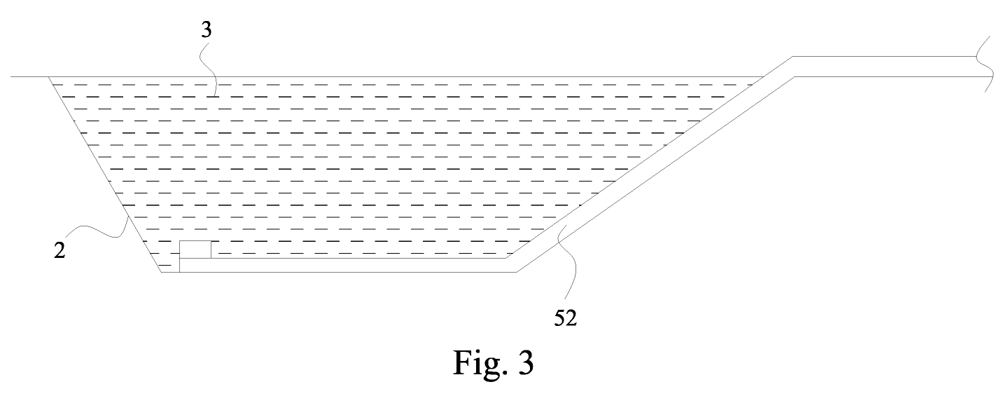

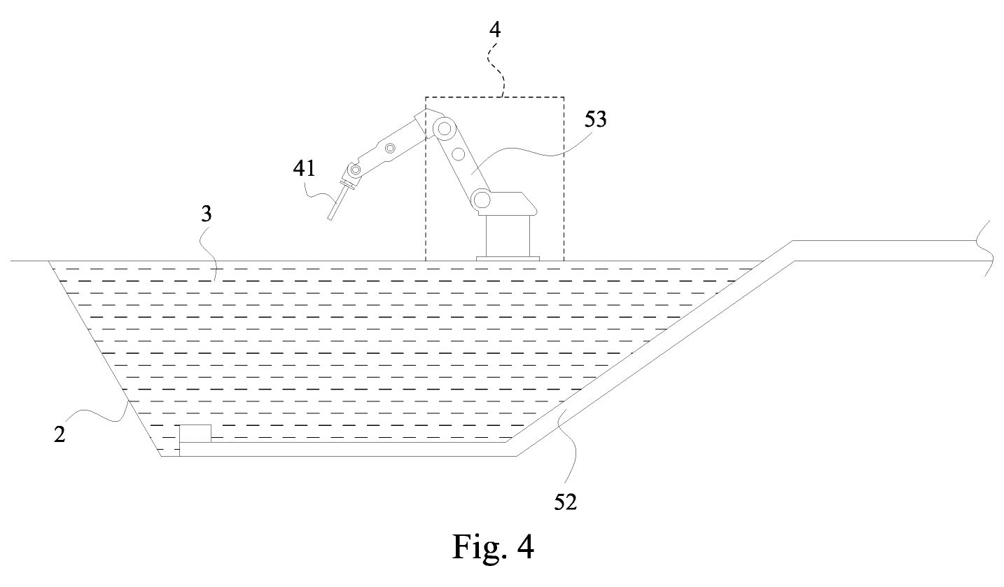

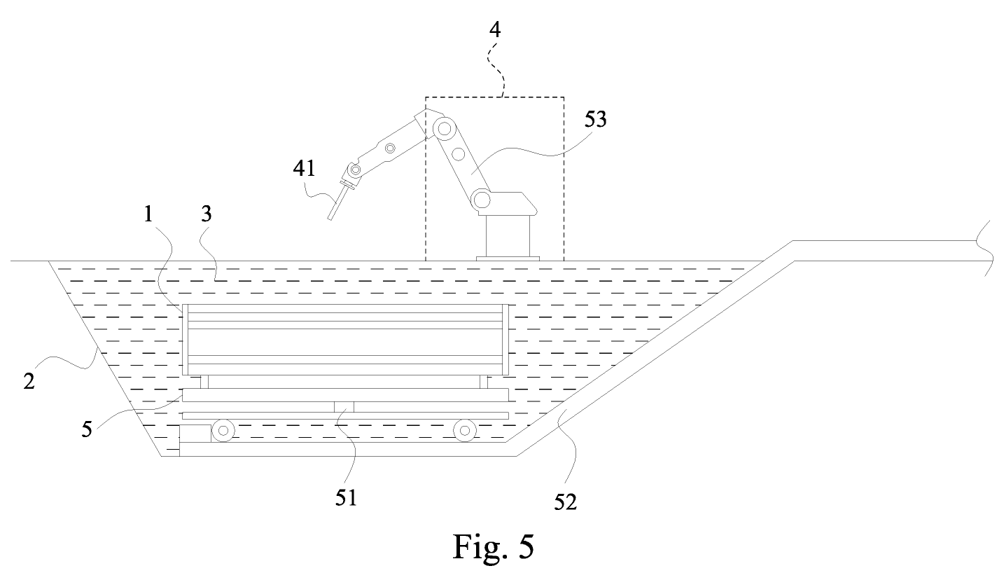

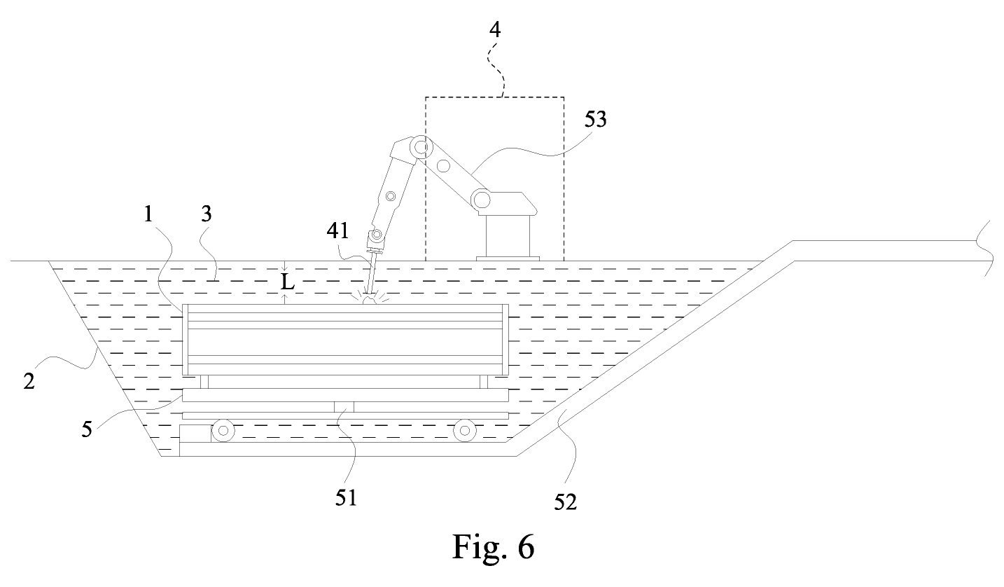

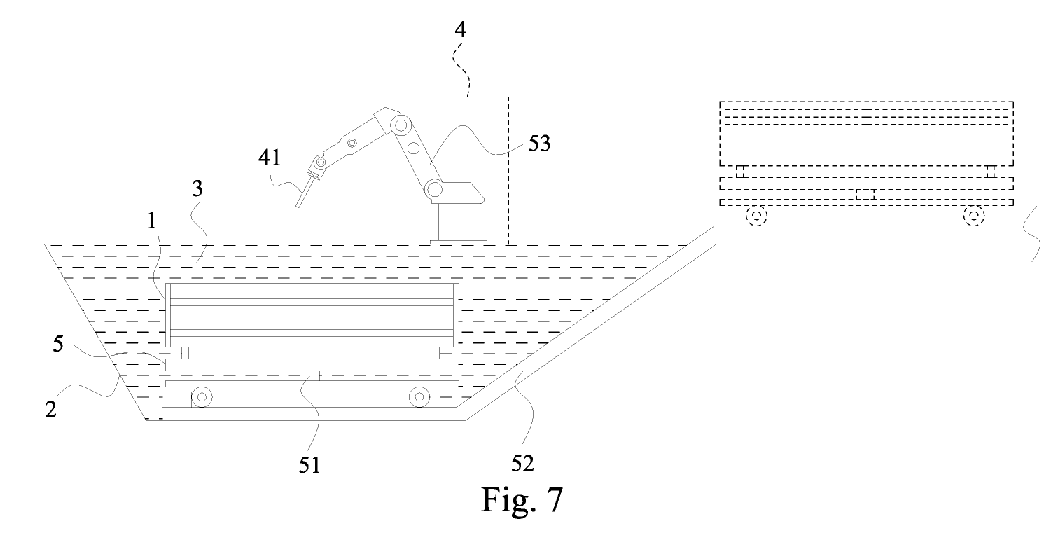

With reference to FIGS. 1 to 7 for the schematic configuration diagrams, a flow chart and schematic diagrams of various preferred embodiment of the present disclosure respectively, a computer cabinet is assembled by welding a plurality of components to be welded 1 including a base, a top cover, a frame and various metal components, for quickly dissipating the heat generated in a welding process to avoid deformation, and the anti-deformation fast heat conduction and dissipation welding method for computer cabinets includes the following steps:

S1: Set a liquid storage space 2 with a size corresponding to the size of the base, the top cover, the frame and the components to be welded after they are combined, and the liquid storage space 2 contains a working fluid 3 for heat dissipation. To improve convenience and durability during subsequent processing, the working fluid 3 of present disclosure is one selected from an anti-rust fluid and a cleaning fluid. In this way, it can avoid the need for subsequent rust prevention and cleaning processes, and also can increase the anti-corrosion effect.

S2: Provide an underwater welding equipment 4 with a welding head 41 that can extend to the liquid storage space 2 to perform a welding process at a set distance L below the liquid surface of the working fluid 3. Noteworthily, actual tests show that the set distance L greater than or equal to 15 centimeters will provide the best underwater welding and heat dissipation effects.

S3: Provide a welding fixture 5 to temporarily fix the components to be welded 1 onto the welding head 41 and then to place the components to be welded 1 into the liquid storage space 2, such that the components to be welded 1 are completely enclosed in the working fluid 3.

S4: Use the welding head 41 of the underwater welding equipment 4 to enter into the working fluid 3 to perform the welding process and to combine the components 1 to be welded as a whole. It is noteworthy that in order to improve the efficiency and operation quality of the welding process, the welding fixture 5 of the present disclosure is equipped with a multi-directional rotating device 51 for rotating the welding fixture 5 at multiple angles to maintain the set distance L of the welding process in order to facilitate operators to adjust the angle for the welding process. Further, to maintain the fast heat dissipation effect, the present disclosure further includes a constant temperature circulation means 6 for connecting the liquid storage space 2 to keep the circulation of the working fluid 3 and maintain at a constant temperature, so there will be no drastic temperature fluctuation, which helps dissipate heat quickly. In addition, according to the welding requirements, such as the requirements for linear welding, the present disclosure provides a slide rail 52, located under the welding fixture 5 for driving the welding fixture 5 to move linearly, so that the welding head 41 can be fixed at the same position to perform the welding process and form a stable movement pattern for linear welding. For multi-point welding, the present disclosure can also provide a robotic arm for fixing the welding head, 41 so that the welding head 41 can be driven by the robotic arm 53 to perform a programmed welding process and the multi-point welding process. The present disclosure can perform the multi-point welding process, or combine the slide rail 52 and the robotic arm 53 at the same time to perform more complicated welding processes.

S5: Place the welding fixture 5 together with the welded components 1 in the working fluid 3 until they cool down, and then remove them from the liquid storage space to complete the welding process.

In this way, the present disclosure provides a computer cabinet of the anti-deformation and fast heat conduction and dissipation welding method that creates a liquid storage space 2 for underwater welding, temporarily fixes various components to be welded 1 and places them below liquid surface, and only allows part of the underwater welding equipment to enter the working fluid 3 in order to perform the welding process. There is no need for operators to enter the working fluid 3 for the operation, not only reducing the difficulty of the process, but also avoiding the potential danger of the operators’ operation in the working fluid 3. This underwater welding technology is used to quickly dissipate the heat generated during the welding process, in order to prevent deformation and replace the related-art welding technologies.

What is claimed is:

1. An anti-deformation and fast heat conduction and dissipation welding method for computer cabinets, wherein each computer cabinet is assembled by welding a plurality of components to be welded, including a base, a top cover, a frame, and a plurality of metal components, for quickly dissipating heat generated in a welding process to avoid deformation, the method comprising:
setting a liquid storage space, with a size corresponding to a size of a combined structure of the plurality of components to be welded, wherein the liquid storage space contains a working fluid for heat dissipation;
providing an underwater welding equipment, with a welding head that is extendable to the liquid storage space, to perform the welding process for a set distance under a liquid surface of the working fluid;
providing a welding fixture to temporarily fix the plurality of components to be welded onto the welding head and then to place the plurality of components to be welded into the liquid storage space, such that the plurality of components to be welded are completely enclosed in the working fluid;
using the welding head of the underwater welding equipment to enter into the working fluid to perform the welding process for combining the plurality of components to be welded as a whole; and
placing the welding fixture together with the combined structure of the plurality of components to be welded in the working fluid until cooled down, and then removing the welding fixture and the combined structure of the plurality of components to be welded from the liquid storage space to complete the welding process.

2. The method according to claim 1, wherein the working fluid is one selected from the group consisting of an anti-rust fluid and a cleaning fluid.

3. The method according to claim 1, wherein the set distance is greater than or equal to 15 centimeters.

4. The method according to claim 1, wherein the welding fixture is provided with a multi-directional rotating device, and the using of the welding head of the underwater welding equipment to enter into the working fluid to perform the welding process for combining the plurality of components to be welded as a whole comprises rotating, by the multi-directional rotating device, the welding fixture at multiple angles to maintain the set distance of the welding process.

5. The anti-deformation fast heat conduction and dissipation welding method for computer cabinets according to claim 1, wherein the using of the welding head of the underwater welding equipment to enter into the working fluid to perform the welding process for combining the plurality of components to be welded as a whole comprises providing a constant temperature circulation means for keeping a circulation of the working fluid and maintaining at a constant temperature, such that no drastic temperature fluctuation during the welding process.

6. The method according to claim 1, wherein a slide rail is further provided and located under the welding fixture, and the using of the welding head of the underwater welding equipment to enter into the working fluid to perform the welding process for combining the plurality of components to be welded as a whole comprises driving, by the slide rail, the welding fixture to move linearly, so that the welding head is fixed at the same position to perform the welding process.

7. The method according to claim 1, wherein a robotic arm is further provided, and the using of the welding head of the underwater welding equipment to enter into the working fluid to perform the welding process for combining the plurality of components to be welded as a whole comprises holding, by the robotic arm, the welding head, so that the welding head is driven by the robotic arm to perform a programmed welding process.
